(19) United States
(12) Patent Application Publication
(10) Pub. No.: US 2026/0145543 A1
(43) Pub. Date: May 28, 2026

(54) WIND-POWERED CHARGER ASSEMBLY FOR AUTOMOBILES

(71) Applicant: Mark Lee Pauler, Wilmore, KY (US)

(72) Inventor: Mark Lee Pauler, Wilmore, KY (US)

(21) Appl. No.: 19/185,443

(22) Filed: Apr. 22, 2025

Related U.S. Application Data
(60) Provisional application No. 63/725,172, filed on Nov. 26, 2024.

(51) Int. Cl. B60L 8/00; F03D 3/04; F03D 3/06; F03D 9/25; F03D 9/32; H02K 7/18

(52) U.S. Cl. CPC B60L 8/006; F03D 3/04; F03D 3/061; F03D 9/25; F03D 9/32; H02K 7/183; F05B 2220/706; F05B 2240/941

(57) ABSTRACT

A wind-powered charger assembly for automobiles includes an alternator, a squirrel cage, a housing, and a wind scoop. The alternator includes a drive shaft and an electrical connector. The electrical connector is designed to connect the alternator to an automobile battery. The squirrel cage is coupled to the drive shaft of the alternator. The housing is positioned about the squirrel cage. The housing includes a top opening through which the squirrel cage partially projects. The wind scoop is mounted on the housing over the top opening. The wind scoop is designed to direct wind to contact the portion of the squirrel cage projecting out of the top opening of the housing to rotate the squirrel cage and the drive shaft of the alternator to generate electricity for the automobile battery. The wind scoop is designed to be mounted on an exterior surface of an automobile.

### (b) CROSS-REFERENCE TO RELATED APPLICATIONS

This application claims the benefit of U.S. Provisional Patent Application No. 63/725,172, filed Nov. 26, 2024.

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to wind-powered chargers and more particularly pertains to a new wind-powered charger assembly for charging the battery of an automobile, such as an electric car or electric truck. Electric automobiles require routine charging. Different passive chargers have been proposed, but they do not generate sufficient energy.

### (2) Description of Related Art Including Information Disclosed Under 37 CFR 1.97 and 1.98

The prior art relates to wind-powered chargers. The prior art, as best understood, does not disclose wind-powered charger assembly that includes an alternator, squirrel cage, and a wind scoop mounted in a hood or roof of an automobile.

### (h) BRIEF SUMMARY OF THE INVENTION

An embodiment of the disclosure meets the needs presented above in a wind-powered charger assembly generally comprising an alternator, a squirrel cage, a housing, and a wind scoop. The alternator includes a drive shaft and an electrical connector. The electrical connector is designed to connect the alternator to an automobile battery. The squirrel cage is coupled to the drive shaft of the alternator. The housing is positioned about the squirrel cage. The housing includes a top opening through which the squirrel cage partially projects. The wind scoop is mounted on the housing over the top opening. The wind scoop is designed to direct wind to contact the portion of the squirrel cage projecting out of the top opening of the housing to rotate the squirrel cage and the drive shaft of the alternator to generate electricity for the automobile battery. The wind scoop is designed to be mounted on an exterior surface of an automobile, such as a hood or a roof.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wind-powered charger assembly according to an embodiment of the disclosure.

FIG. 2 is a front view of an embodiment of the disclosure.

FIG. 3 is a side view of an embodiment of the disclosure.

FIG. 4 is a rear view of an embodiment of the disclosure.

FIG. 5 is a perspective view of an embodiment of the disclosure.

FIG. 6 is a perspective view of an embodiment of the disclosure.

FIG. 7 is a perspective view of an alternative embodiment of the disclosure.

FIG. 8 is an exploded view of an embodiment of the disclosure.

### (j) DETAILED DESCRIPTION OF THE INVENTION

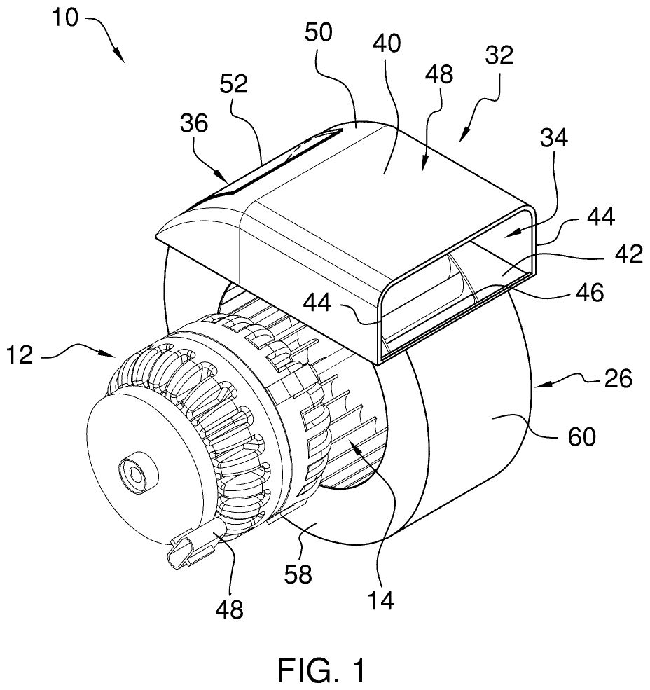

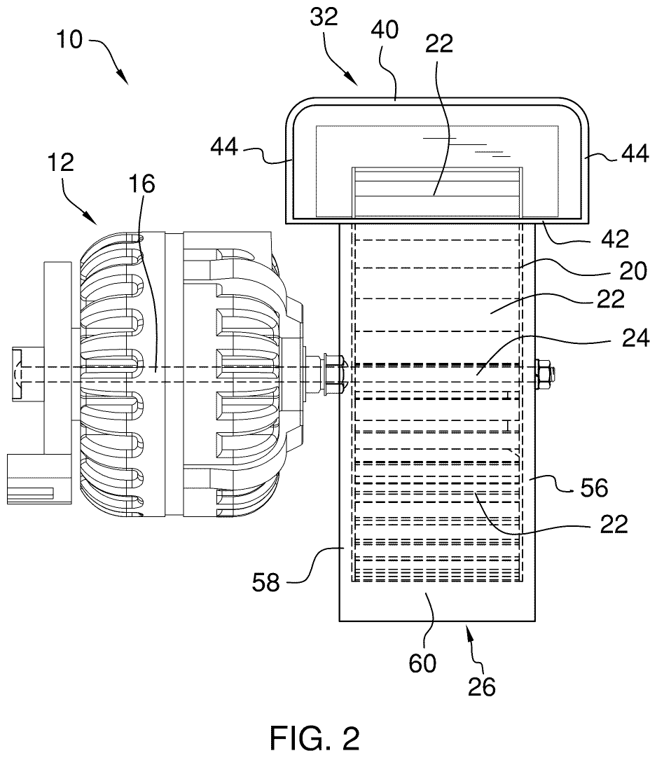

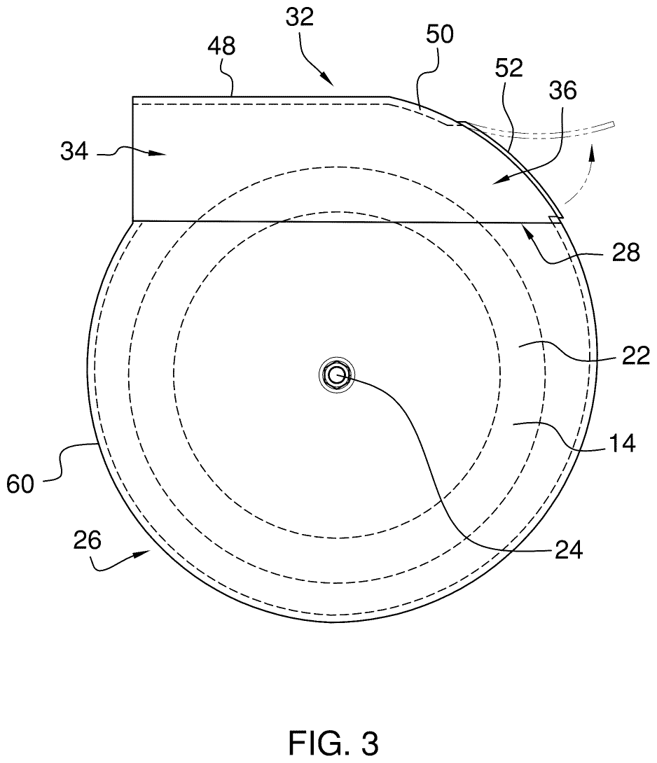

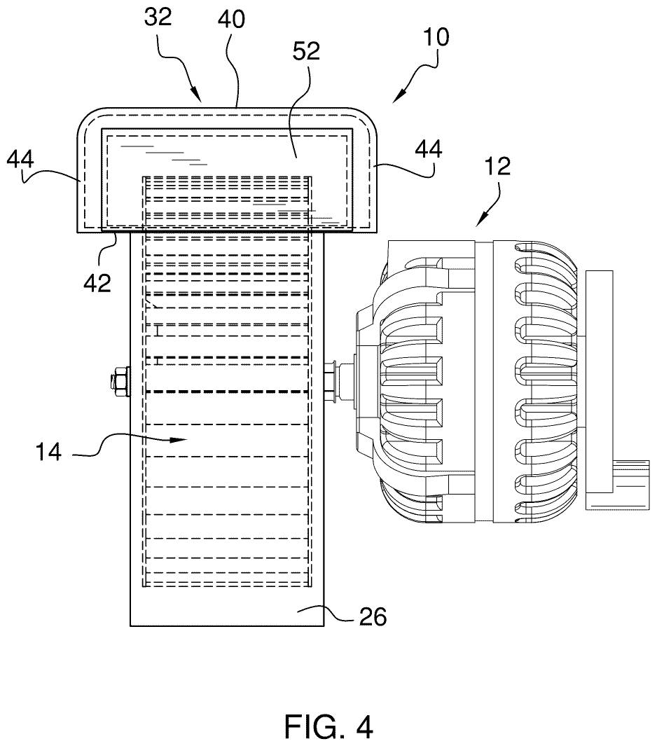

With reference now to the drawings, and in particular to FIGS. 1 through 8 thereof, a new wind-powered charger assembly embodying the principles and concepts of an embodiment of the disclosure and generally designated by the reference numeral 10 will be described.

As best illustrated in FIGS. 1 through 8, the wind-powered charger assembly 10 generally comprises an alternator 12 and a squirrel cage 14. The alternator 12 includes a drive shaft 16. The alternator 12 includes an electrical connector 18 that is designed to connect the alternator 12 to an automobile battery 70. The squirrel cage 14 is coupled to the drive shaft 16 of the alternator 12. A housing 26 is positioned about the squirrel cage 14. The housing 26 includes a top opening 28 through which the squirrel cage 14 partially projects. A wind scoop 32 is mounted on the housing 26 over the top opening 28. The wind scoop 32 is designed to direct wind to contact the portion of the squirrel cage 14 projecting out of the top opening 28 of the housing 26 to rotate the squirrel cage 14 and the drive shaft 16 of the alternator 12 to generate electricity for the automobile battery 70. The wind scoop 32 is designed to be mounted on an exterior surface of an automobile.

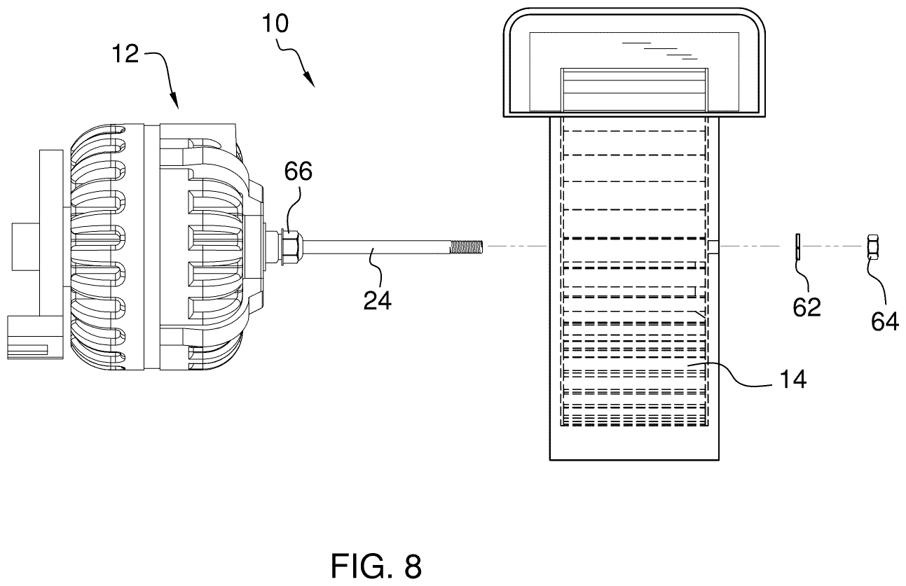

In the exemplary embodiment, the squirrel cage 14 includes: a circular plate 20, a plurality of blades 22 extending perpendicularly from a perimeter portion of the circular plate 20, and an axial bolt 24 extending perpendicularly out of a center of the circular plate 20. The axial bolt 24 is coupled to the drive shaft 16 of the alternator 12. In the exemplary embodiment, the axial bolt is attached to the drive shaft 16, such as by welding, though the axial bolt 24 could be connected in other ways, such as a pin connection. In the exemplary embodiment, the axial bolt 24 extends through the housing 26 to rotatably mount the squirrel cage 14 on the housing 26. In the exemplary embodiment in FIG. 8, for example, the axial bolt 24 is welded to an alternator nut 66. Alternator nuts are well known in the electrical arts serve as a securing piece and provide an excellent transmission of forces. By welding the axial bolt 24 into the alternator nut 66, a very strong connection is produced between the axial bolt 24 and the drive shaft 16 of the alternator 12, as well as excellent transfer of forces from the axial bolt 24 to the drive shaft 16. Also as shown in FIG. 8, the axial bolt 24 can held in place by a washer 62 and nut 64 that about the housing 26.

The housing 26 is in the shape of a partial cylinder terminating at the top opening 28. The housing 26 is positioned to partially enclose the squirrel cage 14 to protect the squirrel cage 14 and guide wind in a circulating manner about the squirrel cage 14. The housing 26 includes a first side wall 56, a second side wall 58, and a perimeter wall 60. The first side wall 56 and the second side wall 58 are positioned on opposite sides of the squirrel cage. The perimeter wall 60 is positioned between and perpendicular to the first side wall 56 and the second side wall 58. The perimeter wall 60 is positioned to extend partially around the squirrel cage. The first side wall 56 is in the shape of a partial circular disk. The second side wall 58 is in the shape of a partial circular ring surrounding an orifice.

In the exemplary embodiment, the wind scoop 32 includes a front opening 34 and a rear opening 36 such that wind can flow through the wind scoop 32 and contact the portion of the squirrel cage 14 projecting out of the top opening 28. The wind scoop 32 includes a top wall 40, a bottom wall 42, and two lateral side walls 44 connecting the top wall 40 and the bottom wall 42. The bottom wall 42 includes a bottom opening 46 aligned with the top opening 28 in the housing 26. The front opening 34 is rectangular. However, this is one possible design of the wind scoop 32, as it could be varied in shape and size. For example, the front opening 34 could be square, oval, or triangular. The height could be larger or smaller. The dimensions of the wind scoop 32 could be varied to achieve different air flow properties.

The top wall 40 includes a flat front portion 48 and a curved rear portion 50 designed to slope downwardly to the bottom wall 42. The rear opening 36 is positioned in the curved rear portion 50 of the top wall 40. The top wall 40 includes a flexible flap portion 52 positioned over the rear opening 36. The flap portion 52 is designed to prevent rain from entering into the vehicle. In addition, the exemplary embodiment shows an opening in the side of the squirrel cage 14 between the squirrel cage 14 and the alternator 12. However, in one possible embodiment, this opening is covered with a moisture barrier, such as a plastic disc or wall sealed with a waterproof sealing material, such as a urethane.

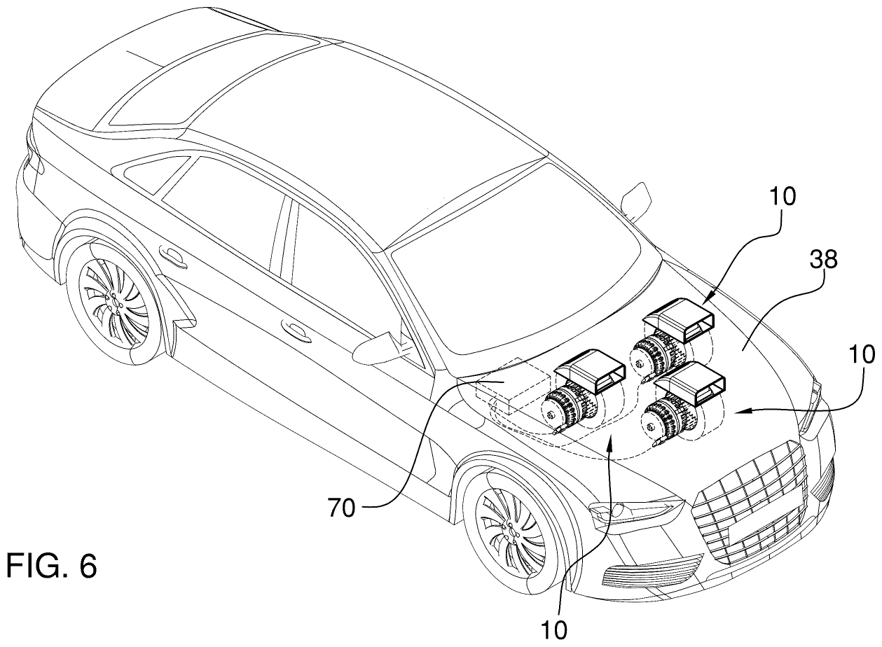

The alternator 12, the squirrel cage 14, the housing 26, and the wind scoop 32 together form a charging device. In the exemplary embodiment in FIG. 6, the wind-powered charger assembly 10 further includes three of the charging devices designed to mounted at an exterior surface of an automobile in a triangular alignment. This is one exemplary embodiment, as more or fewer charging devices could be mounted in essentially any arrangement to optimize air flow.

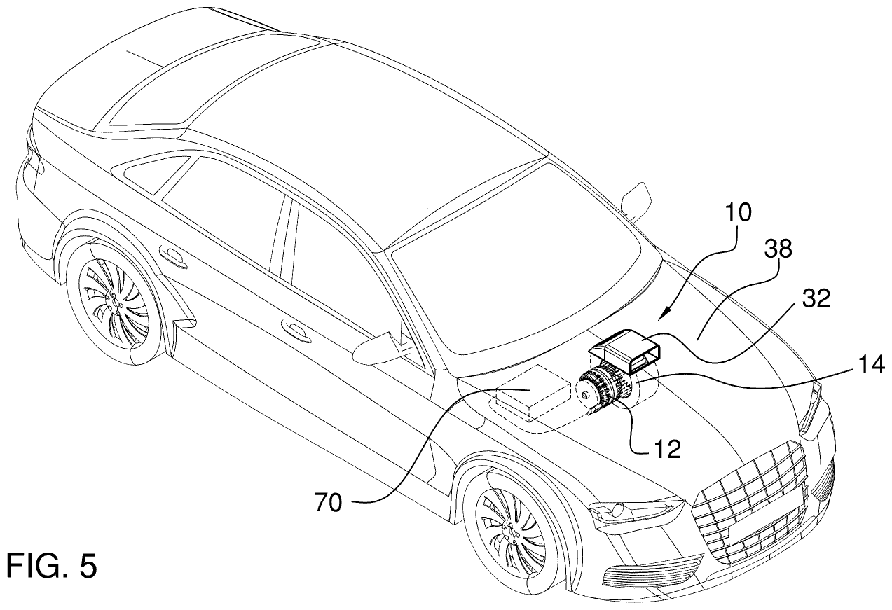

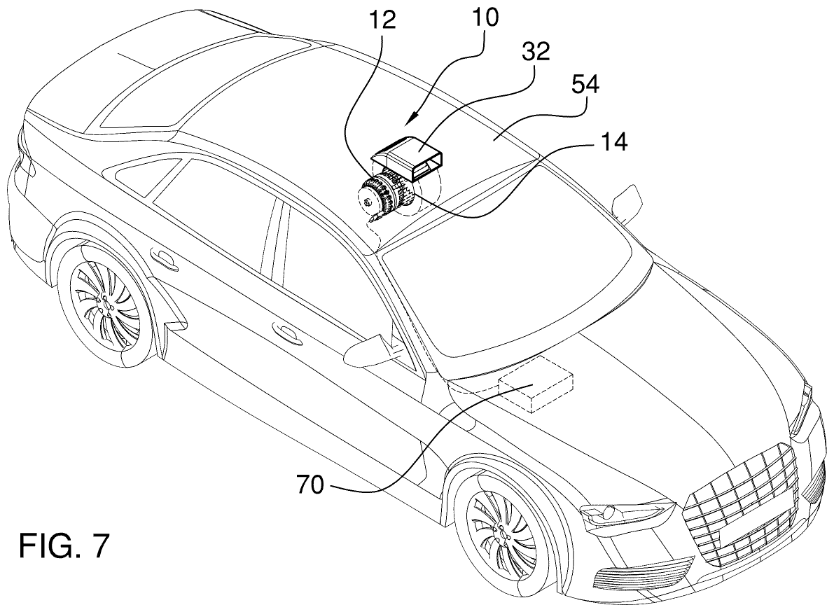

In the exemplary embodiment in FIG. 5, the wind scoop 32 is positioned above an outer surface of an automobile hood 38 and the alternator 12 and housing 26 are positioned below an inner surface of the automobile hood 38. In the exemplary embodiment in FIG. 7, the wind scoop 32 is positioned above an outer surface of an automobile roof 54 and the alternator 12 and housing 26 are positioned below an inner surface of the automobile roof 54.

In the exemplary embodiment, the juncture between the automobile hood 38 or the automobile roof 54 and the wind scoop 32 is sealed, such as by a plastic lip with a urethane sealing material, though any suitable waterproof material could be used. In another possible embodiment, the wind scoop 32 could be integrally formed as part of the automobile hood 38 or the automobile roof, such as during manufacture, and joined by metal or plastic connections, such as plates and bolts or screws. In one possible embodiment, the wind-powered charger assembly 10 includes the automobile hood 38 attached to the wind scoop 32, or alternatively the housing 26, for sale or manufacture as a single unit. In another possible embodiment, the wind-powered charger assembly 10 includes the automobile roof 38 attached to the wind scoop 32, or alternatively the housing 26, for sale or manufacture as a single unit.

In use, natural wind passes over the squirrel cage 14, which can be made of plastic or metal, which is rotated and in turn drives the drive shaft 16 of the alternator 12. The alternator 12 recharges the automobile battery 70 while driving, such as at speeds greater than 50 mph. FIGS. 5 and 7 show one wind-powered charger assembly 10, while FIG. 6 shows three wind-powered charger assemblies 10. For example, the three wind-powered charger assemblies 10 would put out 5680 watts at a speed of 70 mph on a highway, greatly reducing or even eliminating down time depending on the length of the trip. Further, for example, the alternator 12 can put out 1,876.8 watts at 700 rpms. However, it should be noted that these are only examples of one possible embodiment or configuration, and thus the output and electrical production could be varied based on the type of alternator 12 and number of wind-powered charger assemblies 10. In one possible embodiment, the alternator 12 can be 95 amperage, 136 amperage, or other possible amperage.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wind-powered charger assembly for automobiles comprising:
an alternator, the alternator including a drive shaft and an electrical connector, the electrical connector being configured to connect the alternator to an automobile battery;
a squirrel cage, the squirrel cage being coupled to the drive shaft of the alternator;
a housing, the housing being positioned about the squirrel cage, the housing including a top opening through which the squirrel cage partially projects; and
a wind scoop, the wind scoop being mounted on the housing over the top opening, the wind scoop being configured to direct wind to contact the portion of the squirrel cage projecting out of the top opening of the housing to rotate the squirrel cage and the drive shaft of the alternator to generate electricity for the automobile battery, the wind scoop being configured to be mounted on an exterior surface of an automobile.

2. The wind-powered charger assembly for automobiles of claim 1, wherein the squirrel cage includes:
a circular plate;
a plurality of blades, the blades are positioned to extend perpendicularly from a perimeter portion of the circular plate; and
an axial bolt, the axial bolt is positioned to extend perpendicularly out of a center of the circular plate, wherein the axial bolt is coupled to the drive shaft of the alternator.

3. The wind-powered charger assembly for automobiles of claim 2, wherein the axial bolt extends through the housing to rotatably mount the squirrel cage on the housing.

4. The wind-powered charger assembly for automobiles of claim 1, wherein:
the housing is in the shape of a partial cylinder terminating at the top opening; and
the housing is positioned to partially enclose the squirrel cage to protect the squirrel cage and guide wind in a circulating manner about the squirrel cage.

5. The wind-powered charger assembly for automobiles of claim 4, wherein:
the housing includes a first side wall, a second side wall, and a perimeter wall;
the first side wall and the second side wall are positioned on opposite sides of the squirrel cage;
the perimeter wall is positioned between and perpendicular to the first side wall and the second side wall; and
the perimeter wall is positioned to extend partially around the squirrel cage.

6. The wind-powered charger assembly for automobiles of claim 5, wherein:
the first side wall is in the shape of a partial circular disk; and
the second side wall is in the shape of a partial circular ring surrounding an orifice.

7. The wind-powered charger assembly for automobiles of claim 1, wherein the wind scoop includes a front opening and a rear opening such that wind can flow through the wind scoop and contact the portion of the squirrel cage projecting out of the top opening.

8. The wind-powered charger assembly for automobiles of claim 7, wherein:
the wind scoop includes a top wall, a bottom wall, and two lateral side walls connecting the top wall and the bottom wall;
the bottom wall includes a bottom opening aligned with the top opening in the housing; and
the front opening is rectangular.

9. The wind-powered charger assembly for automobiles of claim 8, wherein:
the top wall includes a flat front portion and a curved rear portion configured to slope downwardly to the bottom wall;
the rear opening is positioned in the curved rear portion of the top wall; and
the top wall includes a flexible flap portion positioned over the rear opening.

10. The wind-powered charger assembly for automobiles of claim 3, wherein:
the housing is in the shape of a partial cylinder terminating at the top opening;
the housing is positioned to partially enclose the squirrel cage to protect the squirrel cage and guide wind in a circulating manner about the squirrel cage;
the housing includes a first side wall, a second side wall, and a perimeter wall;
the first side wall and the second side wall are positioned on opposite sides of the squirrel cage;
the perimeter wall is positioned between and perpendicular to the first side wall and the second side wall;
the perimeter wall is positioned to extend partially around the squirrel cage;
the first side wall is in the shape of a partial circular disk; and
the second side wall is in the shape of a partial circular ring surrounding an orifice.

11. The wind-powered charger assembly for automobiles of claim 10, wherein:
the wind scoop includes a front opening and a rear opening such that wind can flow through the wind scoop and contact the portion of the squirrel cage projecting out of the top opening;
the wind scoop includes a top wall, a bottom wall, and two lateral side walls connecting the top wall and the bottom wall;
the bottom wall includes a bottom opening aligned with the top opening in the housing;
the front opening is rectangular;
the top wall includes a flat front portion and a curved rear portion configured to slope downwardly to the bottom wall;
the rear opening is positioned in the curved rear portion of the top wall; and
the top wall includes a flexible flap portion positioned over the rear opening.

12. The wind-powered charger assembly for automobiles of claim 1, wherein the alternator, the squirrel cage, the housing, and the wind scoop together form a charging device, and the wind-powered charger assembly further comprises three of the charging devices configured to be attached to on an exterior surface of an automobile in a triangular alignment.

13. The wind-powered charger assembly for automobiles of claim 12, wherein:
the squirrel cage includes:
a circular plate;
a plurality of blades, the blades are positioned to extend perpendicularly from a perimeter portion of the circular plate; and
an axial bolt, the axial bolt is positioned to extend perpendicularly out of a center of the circular plate, wherein the axial bolt is coupled to the drive shaft of the alternator;
the axial bolt extends through the housing to rotatably mount the squirrel cage on the housing;
the housing is in the shape of a partial cylinder terminating at the top opening;
the housing is positioned to partially enclose the squirrel cage to protect the squirrel cage and guide wind in a circulating manner about the squirrel cage;
the housing includes a first side wall, a second side wall, and a perimeter wall;
the first side wall and the second side wall are positioned on opposite sides of the squirrel cage;
the perimeter wall is positioned between and perpendicular to the first side wall and the second side wall;
the perimeter wall is positioned to extend partially around the squirrel cage;
the first side wall is in the shape of a partial circular disk;
the second side wall is in the shape of a partial circular ring surrounding an orifice;
the wind scoop includes a front opening and a rear opening such that wind can flow through the wind scoop and contact the portion of the squirrel cage projecting out of the top opening;
the wind scoop includes a top wall, a bottom wall, and two lateral side walls connecting the top wall and the bottom wall;
the bottom wall includes a bottom opening aligned with the top opening in the housing;
the front opening is rectangular;
the top wall includes a flat front portion and a curved rear portion configured to slope downwardly to the bottom wall;
the rear opening is positioned in the curved rear portion of the top wall; and
the top wall includes a flexible flap portion positioned over the rear opening.

14. The wind-powered charger assembly for automobiles of claim 1, further comprising an automobile roof being attached to the wind scoop such that the wind scoop is positioned above an outer surface of the automobile roof and the alternator and housing are positioned below an inner surface of the automobile roof.

15. The wind-powered charger assembly for automobiles of claim 14, wherein:
the squirrel cage includes:
a circular plate;
a plurality of blades, the blades are positioned to extend perpendicularly from a perimeter portion of the circular plate; and
an axial bolt, the axial bolt is positioned to extend perpendicularly out of a center of the circular plate, wherein the axial bolt is coupled to the drive shaft of the alternator;
the axial bolt extends through the housing to rotatably mount the squirrel cage on the housing;
the housing is in the shape of a partial cylinder terminating at the top opening;
the housing is positioned to partially enclose the squirrel cage to protect the squirrel cage and guide wind in a circulating manner about the squirrel cage;
the housing includes a first side wall, a second side wall, and a perimeter wall;
the first side wall and the second side wall are positioned on opposite sides of the squirrel cage;
the perimeter wall is positioned between and perpendicular to the first side wall and the second side wall;
the perimeter wall is positioned to extend partially around the squirrel cage;
the first side wall is in the shape of a partial circular disk;
the second side wall is in the shape of a partial circular ring surrounding an orifice;
the wind scoop includes a front opening and a rear opening such that wind can flow through the wind scoop and contact the portion of the squirrel cage projecting out of the top opening;
the wind scoop includes a top wall, a bottom wall, and two lateral side walls connecting the top wall and the bottom wall;
the bottom wall includes a bottom opening aligned with the top opening in the housing;
the front opening is rectangular;
the top wall includes a flat front portion and a curved rear portion configured to slope downwardly to the bottom wall;
the rear opening is positioned in the curved rear portion of the top wall; and
the top wall includes a flexible flap portion positioned over the rear opening.

16. The wind-powered charger assembly for automobiles of claim 1, further comprising an automobile hood being attached to the wind scoop such that the wind scoop is positioned above an outer surface of the automobile hood and the alternator and housing are positioned below an inner surface of the automobile hood.

17. The wind-powered charger assembly for automobiles of claim 16, wherein:
the squirrel cage includes:
a circular plate;
a plurality of blades, the blades are positioned to extend perpendicularly from a perimeter portion of the circular plate; and
an axial bolt, the axial bolt is positioned to extend perpendicularly out of a center of the circular plate, wherein the axial bolt is coupled to the drive shaft of the alternator;
the axial bolt extends through the housing to rotatably mount the squirrel cage on the housing;
the housing is in the shape of a partial cylinder terminating at the top opening;
the housing is positioned to partially enclose the squirrel cage to protect the squirrel cage and guide wind in a circulating manner about the squirrel cage;
the housing includes a first side wall, a second side wall, and a perimeter wall;
the first side wall and the second side wall are positioned on opposite sides of the squirrel cage;
the perimeter wall is positioned between and perpendicular to the first side wall and the second side wall;
the perimeter wall is positioned to extend partially around the squirrel cage;
the first side wall is in the shape of a partial circular disk;
the second side wall is in the shape of a partial circular ring surrounding an orifice;
the wind scoop includes a front opening and a rear opening such that wind can flow through the wind scoop and contact the portion of the squirrel cage projecting out of the top opening;
the wind scoop includes a top wall, a bottom wall, and two lateral side walls connecting the top wall and the bottom wall;
the bottom wall includes a bottom opening aligned with the top opening in the housing;
the front opening is rectangular;
the top wall includes a flat front portion and a curved rear portion configured to slope downwardly to the bottom wall;
the rear opening is positioned in the curved rear portion of the top wall; and
the top wall includes a flexible flap portion positioned over the rear opening.
